(19) United States
(12) Patent Application Publication
(10) Pub. No.: US 2010/0225244 A1
(43) Pub. Date: Sep. 9, 2010

(54) LED penlight bulb

(76) Inventors: Jeng Hua Liu, Lakeland, FL (US); Charles Dennis Ellis, Lakeland, FL (US)

Correspondence Address: Jeng Hua Liu, 1629 Dolphin Drive, Lakeland, FL, 33801, US

(21) Appl. No.: 12/660,828

(22) Filed: Mar. 5, 2010

Related U.S. Application Data
(60) Provisional application No. 61/209,541, filed on Mar. 9, 2009.

(51) Int. Cl. H05B 41/36; H01J 5/48

(52) U.S. Cl. 315/291; 313/318.01

(57) ABSTRACT

The invention presents a new design of one-cell and two-cell LED penlight bulbs and it's embedded PCB electronic circuit board structure, specially shaped LED encapsulation and a base to make it physically interchangeable with standard incandescent penlight bulbs. The bulb houses a super bright LED in a specially shaped, spherical molded top. The leads from the LED are soldered on the PC Board that is embedded inside the base. The PC Board power input ports connect to the metal base. The base and the LED molded encapsulation are attached together by means of bonding (thermal, sonic or solvent), friction interference fit or adhesive. The PC Board utilizes an amplifier design which allows the LED to be powered by either one or two 1.5 volt dry cells. The simple bulb design significantly reduces the weight of the entire product, generates much less heat and also dramatically reduces the power consumption of the penlight.

This utility patent application claims priority to Provisional U.S. Patent Application 61/209,541 filed Mar 9, 2009.

This invention was not supported by federally sponsored research or development.

### FIELD OF THE INVENTION

The present invention relates to the penlight, key ring or pocket type flashlight whether for personal or professional use.

### BACKGROUND

Battery and bulb life have always been a problem with the penlight, the key ring light and the pocket light used by the public and also certain professional people such as doctors, nurses and paramedics. Another problem has been that most LEDs will not light up with only one 1.5 volt battery. One of the unique characteristics of this invention is that all the circuitry needed to run an LED on one 1.5 volt battery is contained in the base of the bulb and is interconnected to allow it to be used in an identical manner as you would an incandescent penlight bulb. This invention solves the “1.5 volt” problem with electronic circuitry and the problems of battery and bulb life by extending the battery life in a small penlight by approximately 20 times and has a bulb life of approximately 5000 times that of an incandescent bulb.

### SUMMARY

This invention is an LED based replacement bulb with the identical physical size of a standard penlight bulb. It is constructed with either a smooth or threaded base. To utilize this bulb you merely need to open the flashlight, remove the existing incandescent bulb and replace it with one of the LED bulbs. The LED bulbs are made with either 1.5 volt or 3.0 volt compatibility which allow you to use it in either a one cell or a two cell flashlight. The LED portion of this bulb has been specially designed to match the glass envelope and metal base shape of a standard incandescent penlight bulb.

### BRIEF DESCRIPTION OF THE DRAWING FIGURES

The above and other aspects, features and advantages of the present disclosure will become more apparent in light of the following detailed description when taken in conjunction with the accompanying drawings in which:

FIG. 1 is a drawing of the LED penlight bulb with a smooth base.

FIG. 2 is a drawing of the LED penlight bulb with a threaded base.

FIG. 3 is an exploded view drawing showing the external and internal parts of the LED penlight bulb and the front or top view of the printed circuit board.

FIG. 4 is an exploded view drawing showing the external and internal parts of the LED penlight bulb and the back or bottom view of the printed circuit board.

FIG. 5 is the schematic for the electronic circuitry of the LED penlight bulb.

### DETAILED DESCRIPTION OF THE EMBODIMENTS

Embodiments of the present disclosure will be described herein below with reference to the accompanying drawings. In the following description, well-known functions or constructions are not described in detail to avoid obscuring the invention in unnecessary detail. Throughout the drawings, like reference numerals represent like elements.

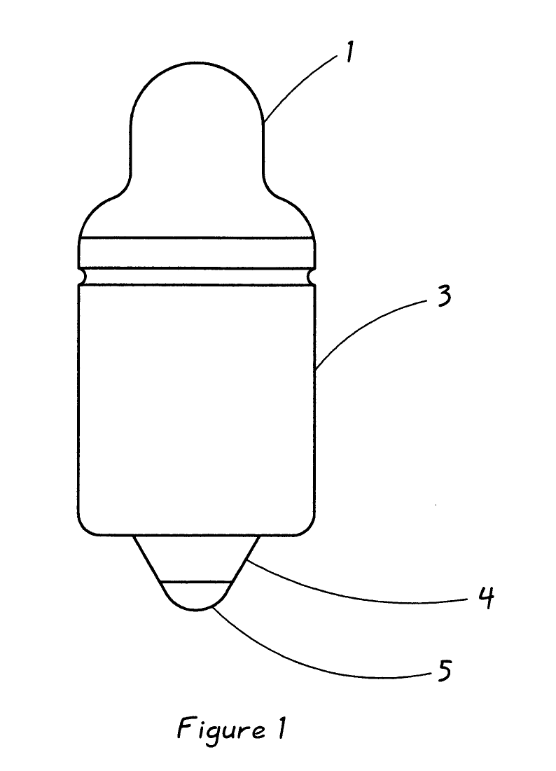

Referring to FIG. 1, a light emitting diode assembly 1 is encapsulated in a specially shaped, molded plastic enclosure. The enclosure is shaped such as to fit in standard penlight flashlights. The LED assembly 1 is retained in the smooth metal base 3 by either heat, friction, adhesive or ultrasonic welding. The metal base is also sized to fit in standard penlight flashlights. A conical glass insulating ring 4 is cemented into the inside bottom of the metal base 3. The insulating glass ring also includes a metal eyelet which allows the positive power lead to pass through to the outside and be attached with a bead of solder 5.

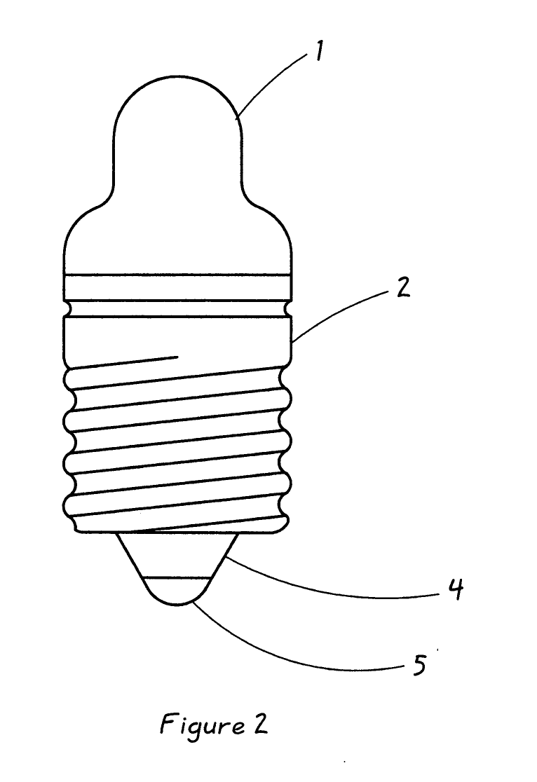

Referring to FIG. 2, a light emitting diode assembly 1 is encapsulated in a specially shaped, molded plastic enclosure. The enclosure is shaped such as to fit in standard penlight flashlights. The LED assembly 1 is retained in the threaded metal base 2 by either heat, friction, adhesive or ultrasonic welding. The metal base is also sized to fit in standard penlight flashlights. A conical glass insulating ring 4 is cemented into the inside bottom of the metal base 2. The insulating glass ring also includes a metal eyelet which allows the positive power lead to pass through to the outside and be attached with a bead of solder 5.

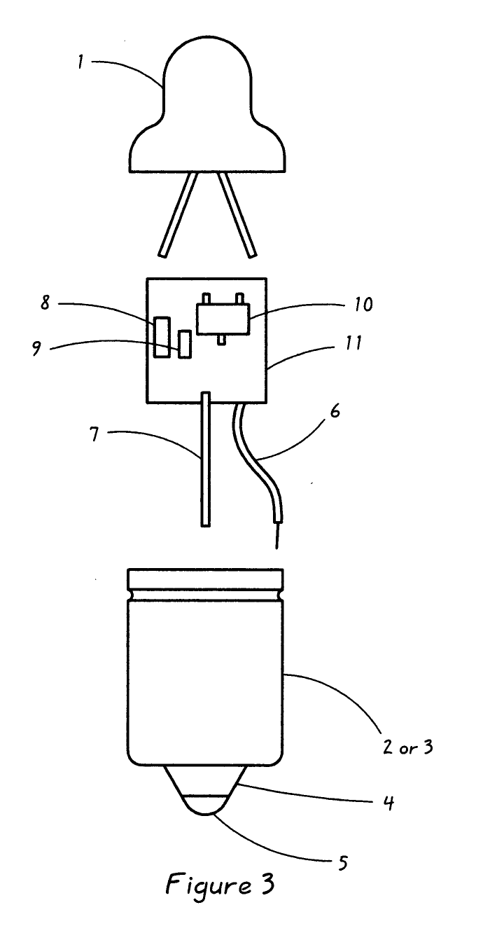

Referring to FIG. 3, the light emitting diode assembly 1 is shown with the two LED connection leads that extend to the PC Board 11. The PC Board is shown from the top view with an amplifier integrated circuit 10, a capacitor 9, a zener diode 8 and the two wire leads that connect the PC Board 11 to the metal base 2 or 3.

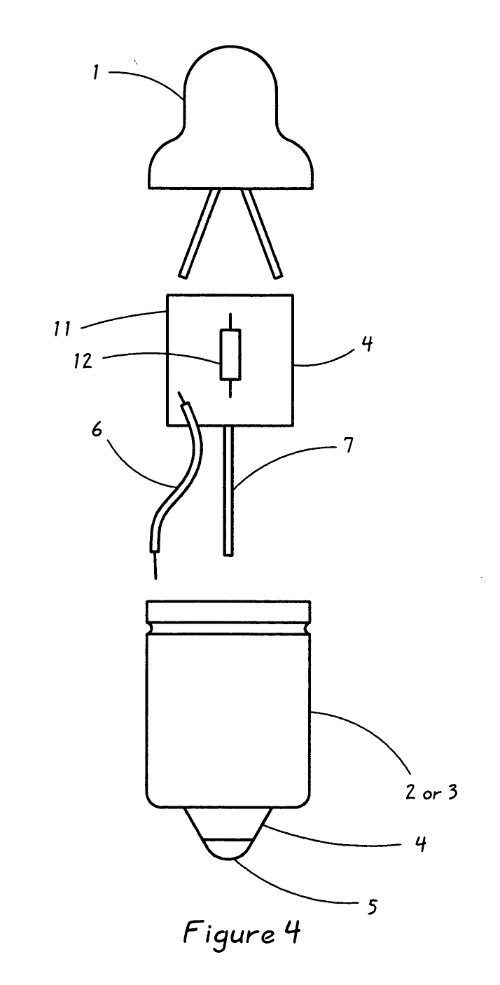

Referring to FIG. 4, the light emitting diode assembly 1 is shown with the two LED connection leads that extend to the PC Board 11. The PC Board is shown from the bottom view with one wire lead 7 that connects the PC Board 11 to the bottom or positive connection of the metal base 2 or 3 and the other wire lead 6 that connects the PC Board to the inside or negative connection of the metal base 2 or 3. The inductor 12 is shown mounted on the bottom side of the PC Board.

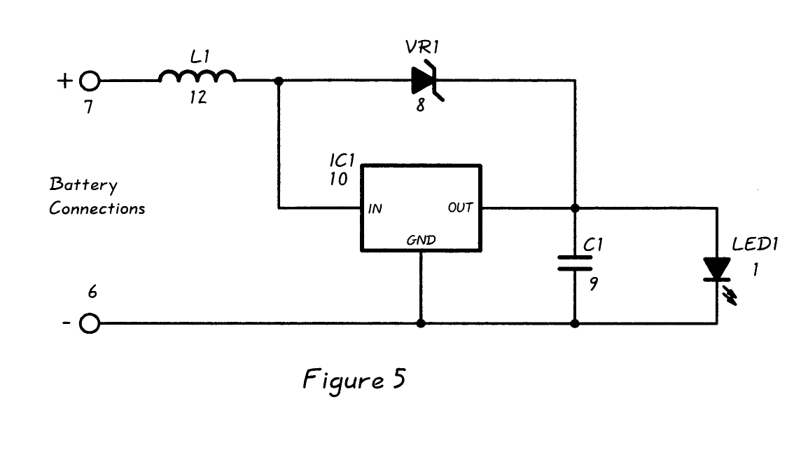

Referring to FIG. 5, a driving circuit for driving the LED is illustrated. The driving circuit includes the connections to the bulb base with 6 being the negative connection & 7 being the positive connection. The driving circuit includes the inductor 12, the zener diode 8, the integrated circuit 10 and the capacitor 9 which modify, amplify and control the voltage, control the current and provide filtering for the power to drive the LED.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. An LED penlight bulb that replaces standard incandescent penlight bulbs comprising:
a. a molded LED junction enclosure shaped and sized to match a standard incandescent penlight bulb;
b. a metal base to provide electrical connections to the circuitry;
c. a smooth or threaded metal base shaped and sized to match a standard incandescent penlight bulb.

2. A printed circuit board comprising:
a. a rectangular substrate designed to fit inside a standard incandescent penlight bulb base;
b. conductor leads that are connected to a direct current source;
c. an integrated circuit, surface mounted chip that modifies and amplifies the input direct current voltage;
d. a z
e. zener diode that controls voltage level;
f. an inductor that controls the current level;
g. a capacitor for filtering the output of the amplifier;
h. the necessary conductors for the connections to the LED.

3. The integrated bulb of claim 1 wherein integrated bulb replaces a standard 1.5 volt incandescent penlight bulb.

4. The integrated bulb of claim 1 wherein integrated bulb replaces a standard 3.0 volt incandescent penlight bulb.
